(19) United States
(12) Patent Application Publication
(10) Pub. No.: US 2001/0032315 A1
(43) Pub. Date: Oct. 18, 2001

(54) Embedding and detecting a watermark in an information signal

(76) Inventors: Cornelis Wilhelmus Antonius Marie Van Overveld, Eindhoven (NL); Peter Maria Johannes Rongen, Eindhoven (NL); Arnold Houwing, Eindhoven (NL)

Correspondence Address: Corporate Patent Counsel, U.S. Philips Corporation, 580 White Plains Road, Tarrytown, NY, 10591, US

(21) Appl. No.: 09/795,004

(22) Filed: Feb. 27, 2001

(30) Foreign Application Priority Data
Feb. 29, 2000 (EP) 00200703.7

(51) Int. Cl. H04L 9/00

(52) U.S. Cl. 713/176

(57) ABSTRACT

A known method of watermarking an information signal is based on extraction of salient points (21) of the signal (e.g. zero crossings in audio, edges of an image) and “warping” (24) said salient points towards a given watermark pattern (W). One step in the embedding and detection process is determining (22) whether or not salient points lie “on” or “off” the watermark. This is a hard decision.

It is now proposed to extend salient points to salient “regions” (25). This turns the step of matching (22) into a soft decision, which is less vulnerable to signal processing. The robustness of the embedded watermark is thereby improved.

### FIELD OF THE INVENTION

The invention relates to a method and arrangement for embedding a watermark in an information signal. The invention also relates to a method and arrangement for detecting an embedded watermark in an information signal.

### BACKGROUND OF THE INVENTION

Digital watermarking is a method of certifying ownership of digital multimedia contents, such as images, video, audio, texts and computer codes. One of the known watermarking methods is based on biasing the statistics of the geometric locations of so-called salient points in an image or audio signal with respect to a secret watermark. Such a prior art watermarking method is disclosed in Applicant's International Patent Application WO-A-99/35836 and will briefly be summarized with reference to FIG. 1.

FIG. 1 shows an image 10 and a watermark 11. The watermark is a secret pattern of image locations. In this example, it is a pseudo-random dense pattern of lines having a thickness d, which covers approximately 50% of the image pixels. The Figure further shows salient points 15 and 16. Salient points are pixels of an image which give the highest response to a defined processing operation. Examples of salient points are local maxima and minima, corners of objects, etc.

The salient points are matched with the watermark W. In the prior art, said matching implies checking whether the salient points are located on or off the watermark. For an unwatermarked image, the number of salient points lying on the watermark is substantially equal to the number of salient points lying off the watermark, provided that the watermark is sufficiently random and covers 50% of the pixels. In FIG. 1, two salient points 15 lie on the watermark, and two salient points 16 lie off the watermark. If a significantly higher percentage of the salient points lies on the watermark pattern, then the watermark is said to be present.

The embedding process includes the same salient point extraction and matching steps as the detection process. The embedder processes the image in such a way that a statistically significant majority of salient points will eventually lie on the watermark. A typical example of salient point modification is geometric warping which causes selected salient points to be moved from a location off the watermark to a location on the watermark. Geometric warping is shown in FIG. 1 in which one of the salient points 16 lying off the watermark is moved to a new position 16′ lying on the watermark.

Instead of determining whether a salient point lies on or off the watermark, the matching step may alternatively measure the distance from the salient points to the nearest line of the watermark. In such an embodiment, in which the lines have no thickness (an example of such a line is denoted 17 in FIG. 1), the image is watermarked by warping it until the average distance of the salient points to the watermark is significantly smaller than the average distance of all pixels to the watermark.

The concept of salient point modification can also be applied to audio signals. In that case, warping is referred to as time warping.

A problem of the prior-art watermarking method is that the matching process must make a hard decision for each salient point as to whether the salient point is on or off the watermark pattern. However, the location of salient points may slightly vary when common image operations are applied to the image. The same problem applies to the embodiment in which the distance of salient pixels to the watermark is decisive. This distance measure also suffers from uncertainty and inaccuracy.

Furthermore, the uncertainty of the geometric location of a salient point may possess some form of anisotropy. That is, the uncertainty in one direction can be much smaller than the uncertainty in another direction. For example, the location of salient points on the edge of an image object has a larger uncertainty along this edge than perpendicular to it.

### OBJECT AND SUMMARY OF THE INVENTION

It is an object of the invention to provide a watermarking method which alleviates the problems of the prior-art method.

To this end, the invention provides a method of watermarking an information signal, comprising the steps of: identifying salient regions of said information signal, each region comprising a plurality of contiguous signal samples having a given saliency; defining a pattern of signal sample locations representing a watermark pattern; and modifying the information signal such that a statistically significant percentage of the watermark pattern is covered by said salient regions.

It is thereby achieved that the process of matching has been turned into ‘soft’ decisions. A salient point is now said to lie on the watermark if at least one of the points of its region lies on the watermark. The robustness of watermark embedding and detection is thereby improved.

The corresponding method of detecting a watermark embedded in an information signal comprises the steps of: identifying salient regions of said information signal, each region comprising a plurality of contiguous signal samples having a given saliency; defining a pattern of signal sample locations representing a watermark to be detected; and determining whether a statistically significant percentage of the watermark pattern is covered by said salient regions.

### BRIEF DESCRIPTION OF THE DRAWINGS

FIG. 1, already discussed, shows an image to illustrate the operation of a prior art watermark embedding and detecting method.

FIG. 2 shows a schematic diagram of a watermark detector in accordance with the invention.

FIG. 3 shows a schematic diagram of a watermark embedder in accordance with the invention.

FIGS. 4, 5, 6A-6B and 7A-7B show diagrams to illustrate the operation of the watermark detector and embedder which are shown in FIGS. 2 and 3, respectively.

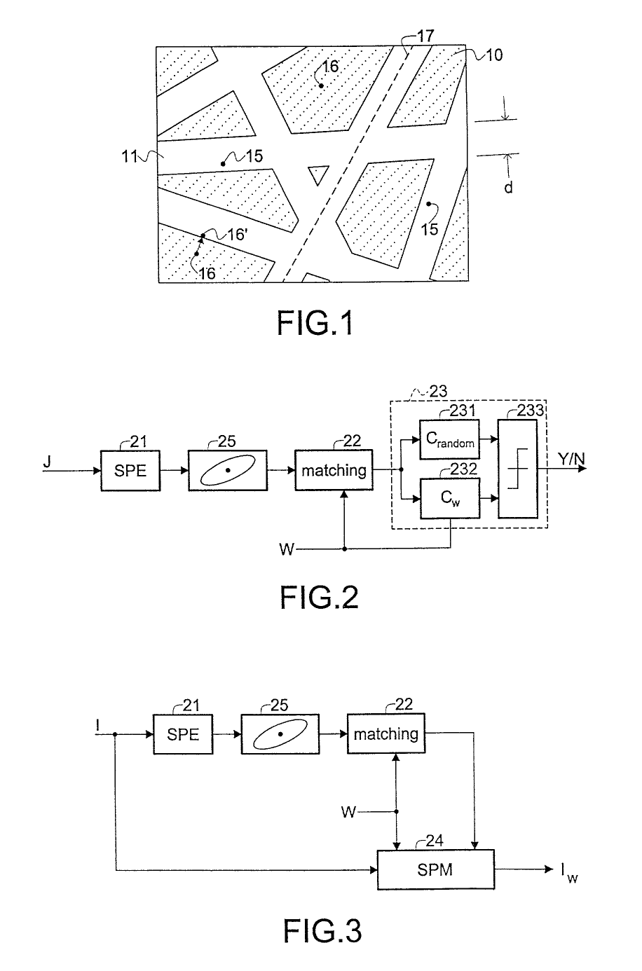

### DESCRIPTION OF PREFERRED EMBODIMENTS

The invention will be described with reference to video watermarking, but can also be applied to other multimedia contents. It is convenient to describe the watermark detection process first. FIG. 2 shows a schematic diagram of a watermark detector in accordance with the invention. The detector receives a suspect image J, and comprises a salient point extraction (SPE) unit 21, a matching unit 22, and a decision unit 23. FIG. 3 shows a schematic diagram of the watermark embedder in accordance with the invention. The embedder receives an unwatermarked image I, and comprises the same salient point extraction unit 21 and matching unit 22 as the watermark detector. The embedder further comprises a salient point modification (SPM) unit 24 which processes the image in such a way that the embedder of FIG. 2 will detect the processed image I_{w} as being a watermarked image.

Salient points are points of an information signal for which a given saliency function S( ) has a local maximum. The saliency function must satisfy certain requirements:

saliency must be a local property, i.e. depend only on a small neighborhood of an image point,

saliency must be preserved under all common kinds of image processing,

saliency must be scale independent, and

saliency must be easily computable.

Salient points are defined as being the locations \vec{p} for which the saliency function S(\vec{p}) is maximal for a small neighborhood N(\vec{p}) of \vec{p}. In mathematical notation, the set S of salient points of an image can be expressed as:

S={\vec{p}|S(\vec{p})≧S(\vec{x}) for \vec{x}εN(\vec{p})}

where \vec{x}denotes coordinates (x,y) and \vec{p} denotes coordinates (p,q) in the two-dimensional image space.

In the prior art, the salient points are applied to the matching unit 22. The known matching algorithm determines whether the salient points are located on or off the watermark. In accordance with one aspect of the invention, the detector and embedder include region assigning means 25 which assign a region to each salient point. The shape of the region designates the small neighborhood N(\vec{p}). To determine the shape, an iso-value curve is computed of the saliency function near \vec{p}. The shape is then defined by the contiguous set of (x,y)-points of the image for which

S(\vec{x})≧S(\vec{p})−ε.

For \vec{x} in a sufficiently small environment around \vec{p}, S(\vec{x}) may be written as:

S(\vec{x})=S(\vec{p})+a(x−p)²+2b(x−p)(y−q)+c(y−q)²

The equation defining the region is thus:

a(x−p)²+2b(x−p)(y−q)+c(y−q)²≦ε

which can also be written more compactly as:

(\vec{x}−\vec{p})^{T}A(\vec{x}−\vec{p})≦ε,

where

$$A = [ \begin{matrix}a & b \\ b & c\end{matrix} ]$$

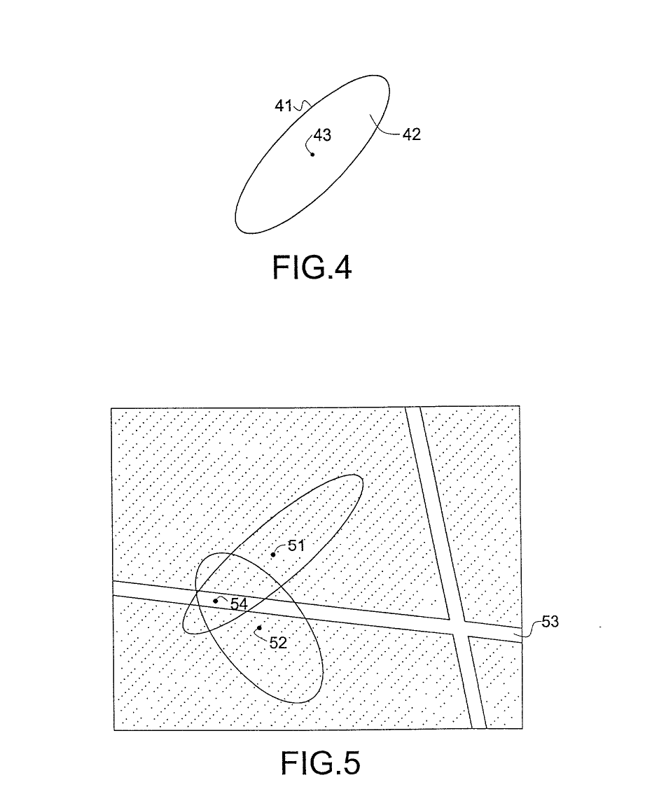

The latter equation represents a quadratic surface, defined by three scalar parameters a, b, and c. The regions have the shape of an ellipse, and this shape determines the anisotropy in the robustness of salient points \vec{p}. The accuracy of \vec{p} in the direction of the long axis is relatively low, and the accuracy in the direction perpendicular to the long axis is relatively high. All the points \vec{x} within the region are said to be salient to the same extent. By way of example, FIG. 4 shows the shape 41 of a region 42 of a particular salient point 43 for a particular saliency function S( ).

The extension of salient points to appropriate regions requires the matching process (22 in FIGS. 2 and 3) to be redefined. Let \vec{p} be a salient point and W the watermark. The ‘soft’ condition for checking if \vec{p} is on the watermark is now that there exists an x ε W such that:

(\vec{x}−\vec{p})^{T}A(\vec{x}−\vec{p})≦ε

for some small ε. In this way, matching of the watermark W with the set S of salient points is softly decided while simultaneously accounting for local anisotropy in the image. FIG. 5 shows an example of two salient points 51 and 52 and a watermark pattern 53. Although the salient points themselves lie off the watermark, they are defined to lie on the watermark because there is at least one point of the corresponding region which lies on the watermark. One such point is denoted 54 in the Figure.

The introduction of salient regions also allows alternative embodiments of the decision process. As shown in FIG. 2, the decision unit 23 includes a first analyzer 231, which computes which percentage of the whole image is covered by ellipses. The complexity of this computation can be reduced in practice by computing said percentage for N randomly selected points of the image. The coverage percentage thus found is denoted C_{random}. Alternatively, C_{random} can be defined as the sum over the reciprocal distances between a random point and the nearest salient point where the ellipse-metric is used. A second analyzer 232 computes a similar coverage percentage C_{w} for the watermark pattern W (or N random points thereof). Again, alternatively, C_{w} is the sum over the reciprocal distances between one watermark point and the nearest salient point, using the ellipse-metric. Subsequently, the decision unit determines (233) whether

$$\frac{\vert {C}_{w} - {C}_{random} \vert}{{C}_{random}} > T$$

where T is a given threshold corresponding to a desired false alarm probability.

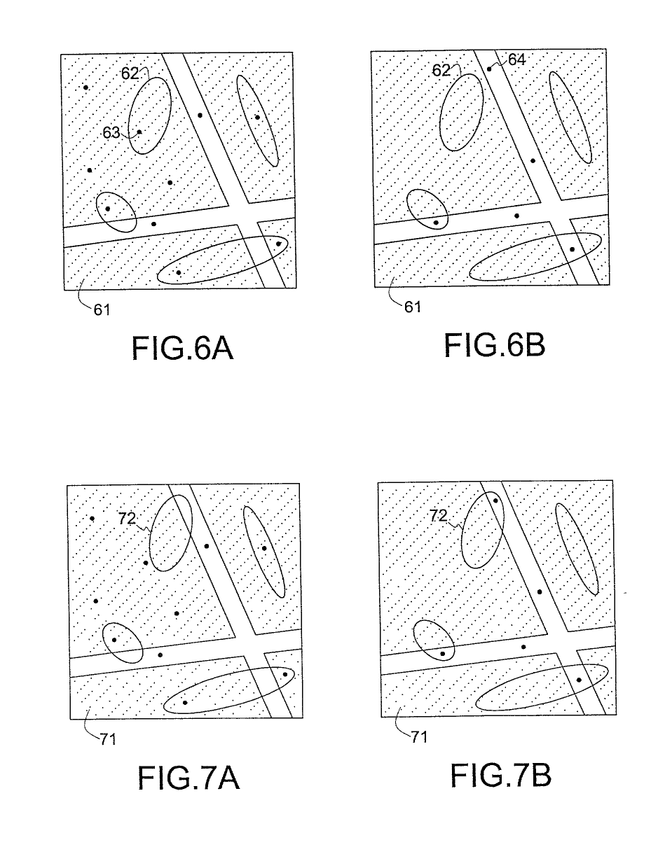

To illustrate the decision process, FIGS. 6A and 6B show an unwatermarked image 61 having four salient regions, one of which is denoted 62. The salient points (the centers of the ellipses) are not shown in this Figure. Ten randomly selected points of the image (one of which is denoted 63) of the unwatermarked image are shown in FIG. 6A. As can easily be verified, five of the ten randomly selected points are covered by a salient region. The coverage percentage C_{random} of the unwatermarked image is thus 50% in this simplified example. Five randomly selected points of the watermark (one of which is denoted 64) are shown in FIG. 6B. Two of them are covered by a salient region, so the coverage percentage C_{w} is 40%. For the unwatermarked image, the decision variable defined above equals:

$$\frac{\vert 40 - 50 \vert}{50} = 0.2$$

FIGS. 7A and 7B illustrate the same process for the watermarked image 71. The salient region 62 (FIG. 6A) has been moved towards the watermark pattern and is now denoted 72. FIG. 7A illustrates that four of the ten randomly selected points of the watermarked image are now covered by an ellipse. For convenience, the same random points are shown as in FIG. 6A. The coverage percentage C_{random} of the watermarked image is thus 40%. FIG. 7B illustrates that three of the five randomly selected points of the watermark are covered by an ellipse, so the coverage percentage C_{w} is 60%. For the watermarked image, the decision variable defined above now equals:

$$\frac{\vert 60 - 40 \vert}{40} = 0.5$$

which is statistically significantly larger than the decision variable of the unwatermarked image. Note that the lines constituting the watermark pattern do not necessarily need to have a thickness.

The invention can be summarized as follows. A known method of watermarking an information signal is based on extraction of salient points (21) of the signal (e.g. zero crossings in audio, edges of an image) and “warping” (24) said salient points towards a given watermark pattern (W). One step in the embedding and detection process is determining (22) whether or not salient points lie “on” or “off” the watermark. This is a hard decision. It is now proposed to extend salient points to salient “regions” (25). This turns the step of matching (22) into a soft decision, which is less vulnerable to signal processing. The robustness of the embedded watermark is thereby improved.

1. A method of watermarking an information signal, comprising the steps of:
identifying salient regions of said information signal, each region comprising a plurality of contiguous signal samples having at least a given saliency;
defining a pattern of signal sample locations representing a watermark pattern; and
modifying the information signal such that a statistically significant percentage of the watermark pattern is covered by said salient regions.

2. A method as claimed in claim 1, wherein said step of identifying a salient region includes identifying a salient signal sample having the highest response to a given local saliency function, and forming the salient region from said salient signal sample and contiguous signal samples having a saliency which differs by less than a given threshold from the saliency of said salient signal sample.

3. A method as claimed in claim 2, wherein said salient regions have ellipse shapes and are expressed as:
(\vec{x}−\vec{p})^{T}A(\vec{x}−\vec{p})≦ε,
where
$$A = [ \begin{matrix}a & b \\ b & c\end{matrix} ]$$
is a matrix of scalars, \vec{p} represents the location of the salient signal sample in the information signal, and E is a given threshold.

4. A method as claimed in claim 1, wherein said statistically significant percentage of the watermark pattern being covered by said salient regions is fulfilled if:
$$\frac{\vert {C}_{w} - {C}_{random} \vert}{{C}_{random}} > T$$
where C_{random} represents a percentage of the information signal being covered by a salient region, C_{w} represents a percentage of the watermark being covered by a salient region, and T is a predetermined threshold.

5. A method as claimed in claim 1, wherein said statistically significant percentage of the watermark pattern being covered by said salient regions is fulfilled if:
$$\frac{\vert {C}_{w} - {C}_{random} \vert}{{C}_{random}} > T$$
where C_{random} represents the sum over the reciprocal distances between random samples of the information signal and the nearest salient signal samples, C_{w} is the sum over the reciprocal distances between locations of the watermark and the nearest salient signal samples, and T is a predetermined threshold.

6. A method of detecting a watermark embedded in an information signal, comprising the steps of:
identifying salient regions of said information signal, each region comprising a plurality of contiguous signal samples having at least a given saliency;
defining a pattern of signal sample locations representing a watermark to be detected; and
determining whether a statistically significant percentage of the watermark pattern is covered by said salient regions.

7. A method as claimed in claim 6, wherein said step of identifying a salient region includes identifying a salient signal sample having the highest response to a given local saliency function, and forming the salient region from said salient signal sample and contiguous signal samples having a saliency which differs by less than a given threshold from the saliency of said salient signal sample.

8. A method as claimed in claim 7, wherein said salient regions have ellipse shapes and are expressed as:
(\dot{x}−\dot{p})^{T}A(\dot{x}−\dot{p})≦ε,
where
$$A = [ \begin{matrix}a & b \\ b & c\end{matrix} ]$$
is a matrix of scalars, \vec{p} represents the location of the salient signal sample in the information signal, and ε is a given threshold.

9. A method as claimed in claim 6, wherein said statistically significant percentage of the watermark pattern being covered by said salient regions is fulfilled if:
$$\frac{\vert {C}_{w} - {C}_{random} \vert}{{C}_{random}} > T$$
where C_{random} represents a percentage of the information signal being covered by a salient region, C_{w} represents a percentage of the watermark being covered by a salient region, and T is a predetermined threshold.

10. A method as claimed in claim 6, wherein said statistically significant percentage of the watermark pattern being covered by said salient regions is fulfilled if:
$$\frac{\vert {C}_{w} - {C}_{random} \vert}{{C}_{random}} > T$$
where C_{random} represents the sum over the reciprocal distances between random samples of the information signal and the nearest salient signal samples, C_{w} is the sum over the reciprocal distances between locations of the watermark and the nearest salient signal samples, and T is a predetermined threshold.

11. An arrangement for embedding a watermark in an information signal, comprising:
means for identifying salient regions of said information signal, each region comprising a plurality of contiguous signal samples having a given saliency;
means for defining a pattern of signal sample locations representing a watermark pattern;
means for modifying the information signal such that a statistically significant percentage of the watermark pattern is covered by said salient regions.

12. An arrangement for detecting a watermark embedded in an information signal, comprising:
means for identifying salient regions of said information signal, each region comprising a plurality of contiguous signal samples having a given saliency;
means for defining a pattern of signal sample locations representing a watermark to be detected;
means for determining whether a statistically significant percentage of the watermark pattern is covered by said salient regions.
